(19) United States
(12) Patent Application Publication
(10) Pub. No.: US 2022/0394920 A1
(43) Pub. Date: Dec. 15, 2022

(54) PORTABLE WORK MACHINE

(71) Applicant: HONDA MOTOR CO., LTD., Minato-ku (JP)

(72) Inventors: Yuki Koike, Wako-shi, Saitama-ken (JP); Shingo Tsuruoka, Wako-shi, Saitama-ken (JP)

(21) Appl. No.: 17/771,510

(22) PCT Filed: Oct. 31, 2019
(86) PCT No.: PCT/JP2019/042951

§ 371 Date: Apr. 25, 2022

(51) Int. Cl. A01D 34/90; A01D 34/416

(52) U.S. Cl. CPC A01D 34/905; A01D 34/416

(57) ABSTRACT

A portable work machine wherein a first region of a shaft facing a handle support part corresponds to the antinode of vibration generated in the shaft. A plurality of bearing members are disposed along the longitudinal direction of the shaft at positions other than the first region in a cylindrical part.

### TECHNICAL FIELD

The present invention relates to a portable work machine in which a handle is supported by a tubular portion via a handle support portion, and power of a drive unit is transmitted to a working unit via a shaft supported by a plurality of bearing members inside the tubular portion.

### BACKGROUND ART

For example, JP S53-062627 A, JP H11-257335 A and JP 5297646 B2 disclose portable work machines. When a handle gripped by an operator is supported by the outer peripheral surface of a tubular portion via a handle support portion, the portable work machine transmits power of a drive unit such as an internal combustion engine to a working unit such as a cutting blade via a shaft inserted into the tubular portion and supported by a plurality of bearing members.

### SUMMARY OF THE INVENTION

When the power of the drive unit is transmitted to the working unit via the shaft and the working unit performs predetermined work, the shaft, the plurality of bearing members, and the tubular portion integrally vibrate due to the vibration of the drive unit or the working unit serving as a vibration source. Accordingly, the vibration of a structure formed of the shaft, the plurality of bearing members, and the tubular portion is transmitted to the handle via the handle support portion.

The present invention has been made in consideration of the above problem, and an object thereof is to provide a portable work machine capable of reducing vibration transmitted to a handle.

According to a first aspect of the present invention, provided is a portable work machine comprising: drive unit; a working unit driven by power of the drive unit; a shaft configured to transmit the power of the drive unit to the working unit; a tubular portion which is disposed between the drive unit and the working unit, and in which the shaft is inserted; a plurality of bearing members configured to support the shaft inside the tubular portion; a handle support portion connected to an outer peripheral surface of the tubular portion; and a handle supported by the handle support portion and gripped by an operator, wherein the shaft includes a first region facing the handle support portion and corresponding to an antinode of vibration generated in the shaft, and the plurality of bearing members are arranged inside the tubular portion, at locations other than the first region along a longitudinal direction of the shaft.

According to a second aspect of the present invention, provided is a portable work machine comprising: a drive unit; a working unit driven by power of the drive unit; a shaft configured to transmit the power of the drive unit to the working unit; a tubular portion which is disposed between the drive unit and the working unit, and in which the shaft is inserted; a plurality of bearing members configured to support the shaft inside the tubular portion; a handle support portion connected to an outer peripheral surface of the tubular portion; and a handle supported by the handle support portion and gripped by an operator, wherein the shaft includes a first region facing the handle support portion and corresponding to an antinode of vibration generated in the shaft, two first bearing members among the plurality of bearing members are arranged so as to sandwich the first region, and an interval between the two first bearing members is wider than an interval between each of the two first bearing members and another bearing member that are adjacent to each other on an outer side of the first region along a longitudinal direction of the shaft.

According to the present invention, the plurality of bearing members are arranged so as to avoid the first region that corresponds to the antinode of vibration generated in the shaft and faces the handle support portion. Therefore, the first region freely vibrates independently of the tubular portion. Accordingly, when vibration of the shaft occurs due to vibration of the driving unit or the working unit serving as the vibration source, excitation energy flows to the first region, and the first region largely vibrates by the excitation energy. As a result, it is possible to prevent the excitation energy from flowing to the tubular portion via the plurality of bearing members and to suppress the vibration of the tubular portion. As described above, in the present invention, it is possible to reduce vibration transmitted from the shaft to the handle via the plurality of bearing members, the tubular portion, and the handle support portion.

### BRIEF DESCRIPTION OF DRAWINGS

FIG. 1 is a perspective view of a work machine according to a present embodiment;

FIG. 2 is a side view of the inside of the work machine of FIG. 1;

FIG. 3 is a cross-sectional view taken along line III-III of FIG. 2;

FIG. 4 is an explanatory view showing reduction of vibration by a first region (first example);

FIG. 5 is an explanatory view showing reduction of vibration by a second region (second example);

FIG. 6 is a diagram showing the relationship between the frequency and the vibration acceleration in the first example;

FIG. 7 is a diagram showing the relationship between the frequency, the displacement, and the phase in a comparative example;

FIG. 8 is a diagram showing the relationship between the frequency, the displacement, and the phase in the first example;

FIG. 9 is a diagram showing the relationship between the frequency and the vibration acceleration in the second example; and

FIG. 10 is a diagram showing the relationship between the frequency and the vibration acceleration in the first example.

### DESCRIPTION OF THE INVENTION

Hereinafter, a preferred embodiment of a portable work machine according to the present invention will be illustrated and described in an exemplary manner with reference to the accompanying drawings.

### 1. Schematic Configuration of Present Embodiment

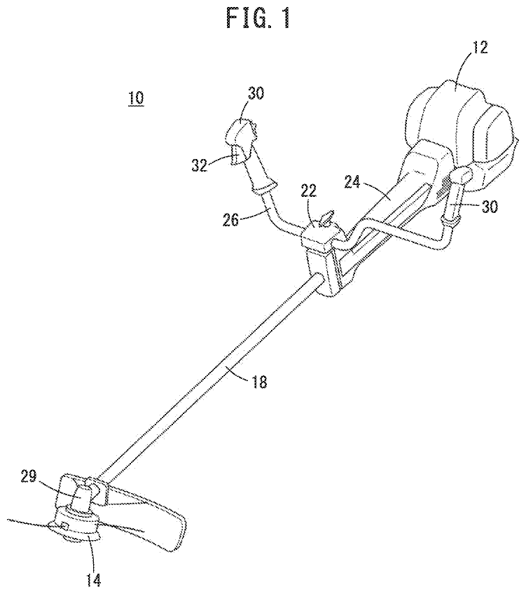

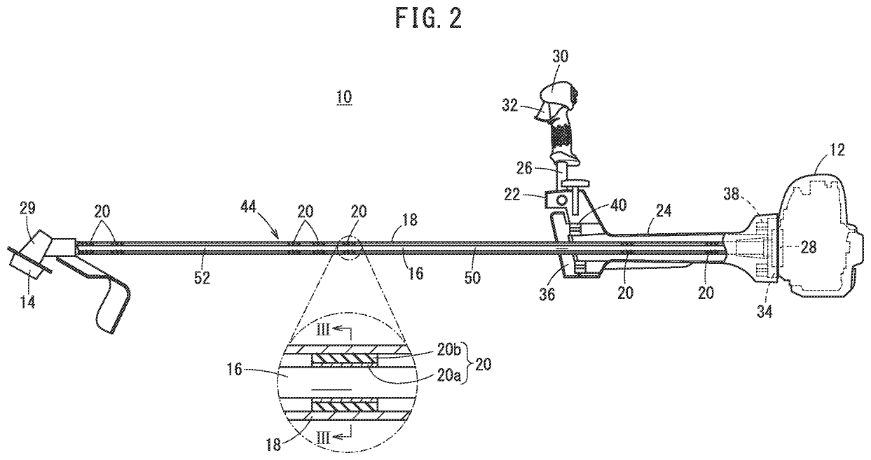

As shown in FIGS. 1 and 2, a portable work machine 10 according to the present embodiment (hereinafter, also referred to as a work machine 10 according to the present embodiment) is a portable brush cutter, and includes a drive unit 12, a working unit 14 driven by the power of the drive unit 12, a shaft 16 that transmits the power of the drive unit 12 to the working unit 14, a tubular portion 18 which is disposed between the drive unit 12 and the working unit 14 and in which the shaft 16 is inserted, and a plurality of bearing members 20 that support the shaft 16 inside the tubular portion 18. A floating box 24 having a handle support portion 22 is provided on the outer peripheral surface of the tubular portion 18 on the drive unit 12 side. A handle 26 gripped by an operator is supported by the handle support portion 22.

The drive unit 12 is provided on the base end side of the shaft 16 and the tubular portion 18 and uses, for example, an internal combustion engine as a drive source thereof. The shaft 16 is, for example, a rod-shaped shaft made of steel, and has a base end connected to the drive source of the drive unit 12 via a clutch 28, and a distal end connected to the working unit 14 via a transmission gear 29. Therefore, power (rotational force) of the drive unit 12 is transmitted to the working unit 14 via the clutch 28, the shaft 16, and the transmission gear 29. Therefore, the drive unit 12 and the working unit 14 may vibrate at different frequencies due to the transmission gear 29. In addition, when the work machine 10 is actually used, the working unit 14 performs predetermined work at a frequency of about 120 Hz. The tubular portion 18 is, for example, an aluminum pipe, and has a base end connected to the drive unit 12, and a distal end connected to the working unit 14.

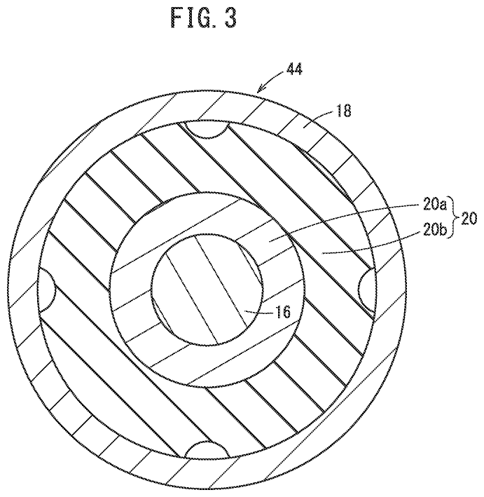

As shown in FIGS. 2 and 3, the plurality of bearing members 20 rotatably support the shaft 16 such that the shaft 16 and the tubular portion 18 are substantially coaxial with each other inside the tubular portion 18. Each of the bearing members 20 is formed of a bushing 20a and an elastic member 20b. The bushing 20a is made of a tubular metal member impregnated with oil, and is in contact with the outer peripheral surface of the shaft 16. The elastic member 20b is made of an oil-resistant tubular rubber member, and is disposed between the outer peripheral surface of the bushing 20a and the inner peripheral surface of the tubular portion 18. The arrangement positions of the plurality of bearing members 20 inside the tubular portion 18 will be described later.

The working unit 14 is, for example, a rotary cutting blade connected to the distal end of the shaft 16, and performs predetermined work by being driven by power (by being rotated by rotational force) transmitted from the drive unit 12 via the clutch 28 and the shaft 16. The handle 26 is provided with a pair of left and right grips 30 that are gripped by the operator during work. One grip 30 is provided with a throttle lever 32 that adjusts the power of the drive unit 12.

A first holding portion 34 is provided at the base end of the tubular portion 18. The first holding portion 34 is connected to the drive unit 12, and covers the clutch 28 and the base end of the tubular portion 18. In addition, a second holding portion 36 is provided at a location separated by a predetermined distance from the base end of the tubular portion 18 toward the working unit 14 along the longitudinal direction of the shaft 16. The second holding portion 36 surrounds the outer peripheral surface of the tubular portion 18. The floating box 24 is disposed on the base end side of the tubular portion 18 so as to be sandwiched between the first holding portion 34 and the second holding portion 36.

A base end of the floating box 24 is connected to the first holding portion 34 via a first vibration absorbing member 38. A distal end of the floating box 24 is connected to the second holding portion 36 via a second vibration absorbing member 40. The handle support portion 22 is attached to the distal end of the floating box 24 on the second holding portion 36 side. The first vibration absorbing member 38 and the second vibration absorbing member 40 are elastic bodies such as rubber, and are provided to suppress vibration transmitted from the base end side of the tubular portion 18 to the handle 26 via the handle support portion 22.

### 2. Characteristic Configuration of Present Embodiment

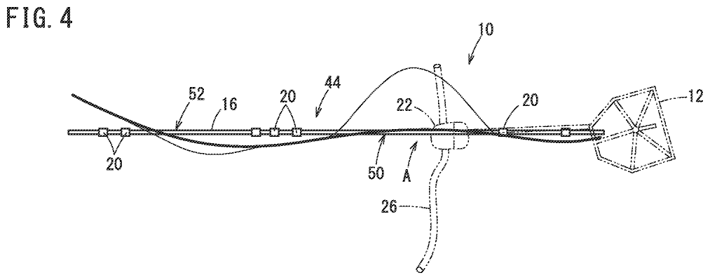

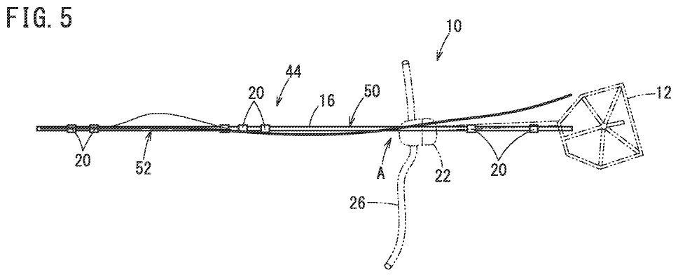

Next, a characteristic configuration of the work machine 10 according to the present embodiment will be described. The characteristic configuration relates to the arrangement of the plurality of bearing members 20 inside the tubular portion 18. In FIGS. 4 and 5, the configuration of the work machine 10 is schematically illustrated in order to highlight the arrangement positions of the plurality of bearing members 20 with respect to the shaft 16.

In the related art, the plurality of bearing members 20 are arranged at equal intervals along the longitudinal direction of the shaft 16 inside the tubular portion 18 (see FIGS. 1 to 3). On the other hand, in the present embodiment, as shown in FIGS. 4 and 5, the plurality of bearing members 20 are arranged at uneven intervals along the longitudinal direction of the shaft 16 inside the tubular portion 18. The reason for the arrangement at uneven intervals is as follows.

Also in the related art, the shaft 16 and the tubular portion 18 are connected to each other via the plurality of bearing members 20. Further, the base end of the shaft 16 is connected to the drive unit 12. The distal end of the shaft 16 is connected to the working unit 14. Therefore, when vibration is generated in the drive unit 12 or the working unit 14 serving as the vibration source, the shaft 16, the plurality of bearing members 20, and the tubular portion 18 integrally vibrate due to the vibration. In this case, if the natural frequency of a structure 44 formed of the shaft 16, the plurality of bearing members 20, and the tubular portion 18 is close to the frequency of the vibration of the drive unit 12 or the working unit 14, the vibration of the structure 44 resonates and becomes larger. The handle support portion 22 is disposed on the outer peripheral surface of the tubular portion 18 via the second holding portion 36 and the second vibration absorbing member 40, and the handle 26 is supported by the handle support portion 22. Therefore, the vibration of the structure 44 is transmitted from the second holding portion 36 to the handle 26 via the second vibration absorbing member 40 and the handle support portion 22.

As described above, in the related art, the mode of vibration (bending vibration mode) generated in the structure 44 is not considered at all, and a plurality of bearing members 20 are uniformly arranged along the longitudinal direction of the shaft 16. Therefore, for example, when any of the bearing members 20 is disposed at a position of the antinode of vibration, the resonating vibration is transmitted from the shaft 16 to the tubular portion 18 via the bearing member 20. As a result, larger vibration is transmitted to the handle 26.

Therefore, in the present embodiment, as shown in FIG. 4 (first example), a portion of the shaft 16 that faces the second holding portion 36, that is, a portion of the shaft 16 onto which the second holding portion 36 is projected is defined as a region A, and the region A is made to correspond to an antinode of vibration generated in the shaft 16. Then, the plurality of bearing members 20 are arranged inside the tubular portion 18, at locations other than the region A along the longitudinal direction of the shaft 16. Specifically, among the plurality of bearing members 20, two bearing members 20 (first bearing members) are arranged on both sides of the region A along the longitudinal direction of the shaft 16. A region including the region A and extending along the longitudinal direction of the shaft 16 so as to correspond to the interval between the two bearing members 20 (a region of the shaft 16 sandwiched between the two bearing members 20) is defined as a first region 50. That is, the two bearing members 20 are arranged so as to sandwich the first region 50 (region A). An interval between the two bearing members 20 is wider than an interval between each of the two bearing members 20 and another bearing member 20 that are adjacent to each other on the outer side of the first region 50 along the longitudinal direction of the shaft 16.

Since the antinode of the vibration is a portion where the vibration is large, the first region 50 is set as an antinode portion that freely vibrates independently of the tubular portion 18. Accordingly, when vibration is generated in the shaft 16 due to vibration of the drive unit 12 or the working unit 14, excitation energy caused by the vibration of the drive unit 12 or the working unit 14 flows to the first region 50, and the first region 50 largely vibrates by the excitation energy. Therefore, it is possible to prevent the excitation energy from flowing to the tubular portion 18 via the plurality of bearing members 20. As a result, vibration of the tubular portion 18 is suppressed, and vibration transmitted to the handle 26 via the handle support portion 22 is reduced.

In this manner, the two bearing members 20 are arranged so as to sandwich the first region 50, and the interval between the two bearing members 20 is set to a length corresponding to the frequency of the vibration generated in the shaft 16. Accordingly, for example, when the interval between the two bearing members 20 is set to a length corresponding to the frequency of the vibration of the working unit 14, the excitation energy caused by the vibration of the working unit 14 flows to the first region 50, and the first region 50 largely vibrates by the excitation energy.

In FIG. 4, when the frequency of the vibration of the working unit 14 is 120 Hz, vibration generated in the shaft 16 is schematically illustrated by a thin line, and vibration generated in the tubular portion 18 is schematically illustrated by a thick line. By providing the first region 50, the first region 50 largely vibrates and vibration of the tubular portion 18 can be reduced.

Further, in the present embodiment, as shown in FIG. 5 (second example), a second region 52 may be provided in the shaft 16 separately from the first region 50. In this case, the second region 52 is made to correspond to an antinode of vibration having a frequency different from the frequency of the vibration corresponding to the first region 50. Then, among the plurality of bearing members 20, two bearing members 20 (second bearing members) are arranged so as to sandwich both ends of the second region 52.

The second region 52 is set as an antinode portion that freely vibrates independently of the tubular portion 18. Accordingly, when vibration is generated in the shaft 16 due to vibration of the drive unit 12 or the working unit 14, excitation energy caused by the vibration of the drive unit 12 or the working unit 14 flows to the second region 52, and the second region 52 largely vibrates by the excitation energy. Also in this case, it is possible to prevent the excitation energy from flowing to the tubular portion 18 via the plurality of bearing members 20, and prevent the tubular portion 18 from vibrating. As a result, vibration transmitted to the handle 26 via the second holding portion 36, the second vibration absorbing member 40, and the handle support portion 22 can be reduced.

Further, the interval between the two bearing members 20 corresponds to the length of the second region 52. In this case, for example, if the interval between the two bearing members 20 is set to a length corresponding to the frequency of the vibration of the drive unit 12, the excitation energy caused by the vibration of the drive unit 12 flows to the second region 52, and the second region 52 largely vibrates by the excitation energy.

In FIG. 5, when the frequency of the vibration of the drive unit 12 is 155 Hz, vibration generated in the shaft 16 is schematically illustrated by a thin line, and vibration generated in the tubular portion 18 is schematically illustrated by a thick line. By providing the second region 52, large vibration is generated in the second region 52 in the shaft 16, and vibration of the tubular portion 18 can be reduced.

Note that FIGS. 4 and 5 illustrate a case in which two regions, namely, the first region 50 and the second region 52 are formed in one shaft 16. In the present embodiment, at least one of the first region 50 or the second region 52 may be formed in one shaft 16.

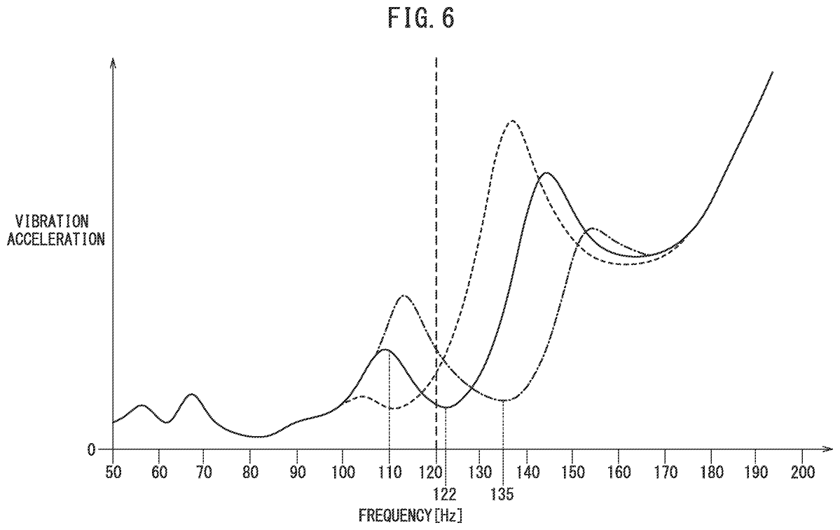

FIG. 6 shows changes in vibration acceleration of the tubular portion 18 when the position of the second holding portion 36 is set as a response point in a case where the interval between the two bearing members 20 sandwiching both ends of the first region 50 is appropriately adjusted in order to reduce vibration caused by the frequency of vibration of the working unit 14 in the first example. The solid line indicates a result in a case where the interval between the two bearing members 20 sandwiching both ends of the first region 50 is set such that the natural frequency of the shaft 16 in the first region 50 becomes 122 Hz. The broken line indicates a result in a case where the interval between the two bearing members 20 is set such that the natural frequency of the shaft 16 in the first region 50 becomes 110 Hz. The alternate long and short dash line indicates a result in a case where the interval between the two bearing members 20 is set such that the natural frequency of the shaft 16 in the first region 50 becomes 135 Hz.

In this manner, the interval between the two bearing members 20 sandwiching both ends of the first region 50 is appropriately adjusted in accordance with the frequency of vibration to be reduced. As a result, the first region 50 can be vibrated independently of the tubular portion 18 and in synchronization with the vibration frequency of the working unit 14. Accordingly, the excitation energy caused by the vibration of the working unit 14 flows to the first region 50. Therefore, vibration of the tubular portion 18 at the position of the second holding portion 36 (response point) is suppressed. As a result, the vibration transmitted to the handle 26 can be reduced. Therefore, by using the method of the present embodiment, it is possible to optimize vibration reduction. For example, even when the design of the reduction ratio of the transmission gear 29 for driving the working unit 14 is altered and the vibration frequency of the working unit 14 is changed, the vibration reduction can be optimized by appropriately adjusting the interval between the two bearing members 20 sandwiching the first region 50.

More specifically, in the above-described method, vibration is reduced by effectively utilizing an antiresonance phenomenon (antiresonance frequency). Here, the antiresonance frequency refers to a frequency at which vibration existing between adjacent resonance frequencies has a minimum value at a certain response point (the position of the second holding portion 36 in FIGS. 4 and 5).

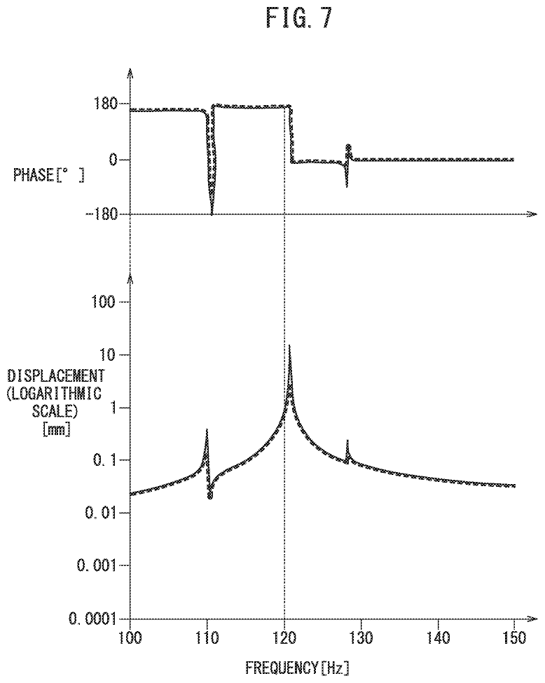

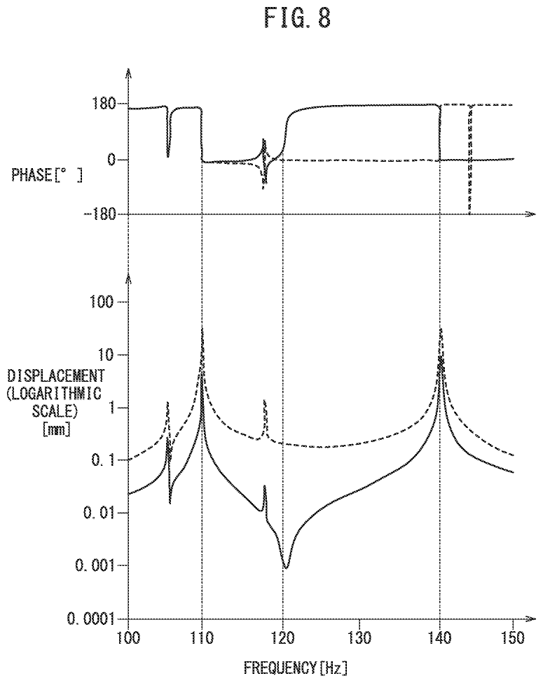

FIG. 7 (comparative example) shows changes in phase and displacement of the shaft 16 (broken line) and the tubular portion 18 (solid line) with respect to the frequency when the position of the second holding portion 36 is set as a response point in a case where the plurality of bearing members 20 are arranged at equal intervals along the longitudinal direction of the shaft 16. Further, FIG. 8 shows changes in phase and displacement of the shaft 16 (broken line) and the tubular portion 18 (solid line) with respect to the frequency when the position of the second holding portion 36 is set as a response point in the first example.

In the comparative example of FIG. 7, the shaft 16 and the tubular portion 18 vibrate integrally, and resonance occurs at a natural frequency of 120 Hz. Further, the shaft 16 and the tubular portion 18 change in the same phase with respect to the frequency.

On the other hand, in the first example of FIG. 8, by adjusting the arrangement of the plurality of bearing members 20, the shaft 16 and the tubular portion 18 resonate on the low frequency side (110 Hz) and the high frequency side (140 Hz) with a frequency of 120 Hz therebetween. That is, in the first example, the resonance at 120 Hz in the comparative example of FIG. 7 is separated into the resonance at two natural frequencies of 110 Hz and 140 Hz. In this case, on the low frequency side of 110 Hz, the shaft 16 and the tubular portion 18 change in the same phase. Further, on the high frequency side of 140 Hz, the shaft 16 and the tubular portion 18 change in opposite phases.

Therefore, in the first example, the natural frequency is separated into two natural frequencies on the low frequency side and the high frequency side, and the phase of the tubular portion 18 is inverted to the phase of the shaft 16 on the high frequency side. As a result, antiresonance can be generated at 120 Hz with respect to the displacement of the vibration of the tubular portion 18. That is, it is possible to generate a frequency range in which the displacement of the vibration has the minimum value, between the two separated natural frequencies.

In this manner, if the natural frequency of the first region 50 is set to 120 Hz, a frequency range in which the vibration is minimized is generated, and it is possible to effectively reduce the vibration with respect to the excitation frequency of the working unit 14 of, for example, 120 Hz. The vibration can be reduced based on the same principle for other natural frequencies (110 Hz, 135 Hz) in FIG. 6.

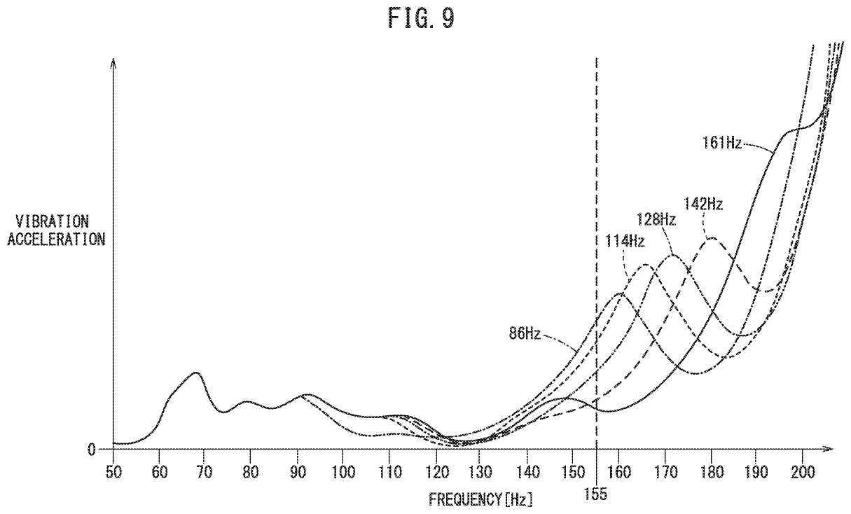

FIG. 9 shows changes in vibration acceleration of the tubular portion 18 in a case where the interval between the two bearing members 20 sandwiching both ends of the second region 52 is appropriately adjusted in order to reduce vibration caused by the frequency of vibration of the drive unit 12 in the second example. In this case, when the natural frequency of the shaft 16 in the second region 52 is changed to 86 Hz, 114 Hz, 128 Hz, 142 Hz, and 161 Hz in accordance with the interval between the two bearing members 20 sandwiching both ends of the second region 52, the resonance peak of the tubular portion 18 is shifted to the high frequency side. Accordingly, even when the target frequency of the vibration of the drive unit 12 to be reduced is 155 Hz, the vibration at 155 Hz is suppressed by appropriately adjusting the interval between the two bearing members 20 sandwiching both ends of the second region 52. Accordingly, vibration transmitted to the handle 26 can be reduced.

It should be noted that, as exemplified by the second region 52, when the region in which the shaft 16 vibrates independently of the tubular portion 18 is provided at a location shifted from the response point (the position of the second holding portion 36 in the tubular portion 18) at which vibration is to be reduced, a shift occurs between the natural frequency of the second region 52 determined based on the interval between the two bearing members 20 and the frequency range in which vibration is most reduced at the response point. In this case, the optimum arrangement of the bearing members 20 for reducing vibration may be examined while confirming the frequency response at the response point by utilizing CAE (Computer Aided Engineering) analysis or the like.

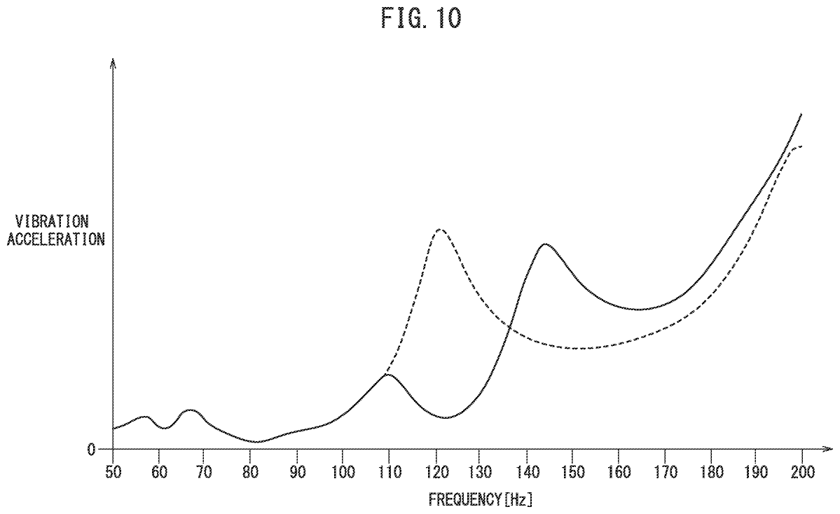

FIG. 10 shows changes in vibration acceleration with respect to the frequency in a low frequency region equal to or lower than 110 Hz when the interval between the two bearing members 20 sandwiching both ends of the first region 50 is changed in the first example. The solid line indicates the result of the first example. The broken line indicates the result of the comparative example. In a case where the frequency of the vibration to be reduced is equal to or higher than 110 Hz, even if the interval between the two bearing members 20 is changed in accordance with the frequency of the vibration to be reduced, it is possible to suppress an influence on the low frequency region equal to or lower than 110 Hz. This is because the effect of separating the vibration modes of the tubular portion 18 and the shaft 16 due to the arrangement adjustment of the bearing members 20 remarkably appears in third or higher order bending modes of the tubular portion 18, and therefore, the effect of separating the vibration modes of the tubular portion 18 and the shaft 16 is small in a low frequency region where the order of bending is low, even if the arrangement adjustment of the bearing members 20 is performed. Therefore, in the present embodiment, it is possible to reduce the vibration at the frequency to be reduced, in the high frequency range in which the use frequency is high in practice, without affecting the frequency range of other practical rotation speed ranges.

### 3. Effects of Present Embodiment

As described above, the work machine 10 according to the present embodiment includes the drive unit 12, the working unit 14 driven by the power of the drive unit 12, the shaft 16 that transmits the power of the drive unit 12 to the working unit 14, the tubular portion 18 which is disposed between the drive unit 12 and the working unit 14 and in which the shaft 16 is inserted, the plurality of bearing members 20 that support the shaft 16 inside the tubular portion 18, the handle support portion 22 connected to the outer peripheral surface of the tubular portion 18, and the handle 26 supported by the handle support portion 22 and gripped by the operator. In this case, the first region 50 of the shaft 16 that faces the handle support portion 22 corresponds to the antinode of vibration generated in the shaft 16, and the plurality of bearing members 20 are arranged inside the tubular portion 18, at locations other than the first region 50 along the longitudinal direction of the shaft 16.

Further, in the work machine 10 according to the present embodiment, the first region 50 of the shaft 16 that faces the handle support portion 22 corresponds to the antinode of vibration generated in the shaft 16, two first bearing members 20 among the plurality of bearing members 20 are arranged so as to sandwich the first region 50, and the interval between the two bearing members 20 is wider than an interval between each of the two bearing members 20 and another bearing member 20 that are adjacent to each other on the outer side of the first region 50 along the longitudinal direction of the shaft 16.

In this manner, the plurality of bearing members 20 are arranged so as to avoid the first region 50 that corresponds to the antinode of the vibration generated in the shaft 16 and faces the handle support portion 22. Therefore, the first region 50 freely vibrates independently of the tubular portion 18. Accordingly, when vibration of the shaft 16 occurs due to vibration of the drive unit 12 or the working unit 14 serving as the vibration source, excitation energy flows to the first region 50, and the first region 50 largely vibrates by the excitation energy. As a result, it is possible to prevent the excitation energy from flowing to the tubular portion 18 via the plurality of bearing members 20, and to suppress the vibration of the tubular portion 18. As described above, in the present embodiment, it is possible to reduce vibration transmitted from the shaft 16 to the handle 26 via the plurality of bearing members 20, the tubular portion 18, and the handle support portion 22.

More specifically, in the present embodiment, the plurality of bearing members 20 are arranged close to the node of vibration in a region of the shaft 16 near the handle support portion 22. Accordingly, the first region 50 is formed as a free region in which the shaft 16 can freely vibrate independently of the tubular portion 18 without being constrained by the bearing members 20. Accordingly, since the natural frequency (resonance frequency) of the structure 44 is shifted, the first region 50 largely vibrates in synchronization with the frequency (excitation frequency) of the drive unit 12 or the working unit 14. As a result, the excitation energy flowing to a portion of the tubular portion 18 where the tubular portion 18 is connected to the handle support portion 22 is reduced, and the vibration of the handle 26 is therefore greatly suppressed.

In this case, among the plurality of bearing members 20, two bearing members 20 (first bearing members) are arranged so as to sandwich the first region 50, and the interval between the two bearing members 20 is set to a length corresponding to the frequency of the vibration. This makes it possible to reduce vibration at any frequency. That is, if the interval between the two bearing members 20 is set such that the frequency (resonance frequency) corresponding to the first region 50 matches the excitation frequency, it is possible to reduce the vibration at the excitation frequency.

Therefore, the vibration can be effectively reduced as compared with the case where the bearing members 20 are simply arranged at the positions of the nodes of the bending vibration mode. In addition, even if the arrangement of the bearing members 20 is changed, it is not necessary to consider an influence on other frequency ranges (for example, a range of an idle rotation speed of several tens of Hz).

In addition, vibrations at a plurality of frequencies are generated in the shaft 16 and the tubular portion 18, and in order to cope with the vibrations at the plurality of frequencies, the second region 52 is provided in the shaft 16 along the longitudinal direction of the shaft 16 separately from the first region 50. The second region 52 corresponds to an antinode of vibration different from the vibration corresponding to the first region 50. Two bearing members 20 (second bearing members) are arranged so as to sandwich both ends of the second region 52, and the interval between the two bearing members 20 is set to a length corresponding to the frequency of the vibration corresponding to the second region 52. As a result, it is possible to take measures to reduce vibrations at a plurality of frequencies independently.

Specifically, the frequency of the vibration corresponding to the first region 50 corresponds to the frequency of vibration of the working unit 14, and the frequency of the vibration corresponding to the second region 52 corresponds to the frequency of vibration of the drive unit 12. Accordingly, it is possible to suitably reduce each vibration caused by the vibration source of the work machine 10.

More specifically, free regions (the first region 50 and the second region 52) are formed at a plurality of locations of the shaft 16, and the lengths of these free regions are adjusted by adjusting the interval between the bearing members 20, whereby it is possible to simultaneously and independently reduce vibrations at a plurality of excitation frequencies. For example, in a case where the excitation frequency of the internal combustion engine serving as the drive unit 12 is set to 155 Hz and the excitation frequency of the cutting blade serving as the working unit 14 is set to 120 Hz, it is possible to take measures to reduce vibrations at the two excitation frequencies independently by providing two free regions having different lengths in the shaft 16.

Further, in vibration reduction measures in the related art, when the resonance at one excitation frequency is to be avoided, there is a possibility that the vibration at the other excitation frequency becomes rather large. On the other hand, in the present embodiment, as described above, it is possible to reduce vibrations at respective excitation frequencies by providing a plurality of free regions in the shaft 16.

### 4. Other Configurations, Etc.

In the work machine 10 according to the present embodiment, the plurality of bearing members 20 are arranged at uneven intervals along the longitudinal direction of the shaft 16 inside the tubular portion 18. That is, the plurality of bearing members 20 are arranged on the node side of the vibration generated in the shaft 16 or the tubular portion 18. Since the node of vibration is a portion where the vibration is small, the transmission of vibration between the shaft 16 and the tubular portion 18 is suppressed. That is, the plurality of bearing members 20 function as members that separate the vibration of the shaft 16 and the vibration of the tubular portion 18, and reduce the vibration transmissibility between the shaft 16 and the tubular portion 18. As a result, the shaft 16 and the tubular portion 18 vibrate in independent modes (bending vibration modes). As a result, the occurrence of resonance is suppressed, and the structure 44 can be prevented from integrally vibrating.

In addition, by making the arrangement uneven, the natural frequency of the structure 44 can be changed to any frequency. Accordingly, the natural frequency of the structure 44 changes to a frequency range different from that of the frequency of the vibration of the drive unit 12 or the working unit 14. As a result, the occurrence of resonance in the structure 44 can be avoided. Specifically, two or three bearing members 20 are collectively arranged at each of a plurality of nodes of vibration in the structure 44. Thus, the frequency of the vibration of the drive unit 12 or the working unit 14 is shifted from the natural frequency of the structure 44. As a result, the vibration acceleration of the tubular portion 18 is suppressed, and the vibration acceleration of the handle 26 is also suppressed.

Further, in the present embodiment, the plurality of bearing members 20 are arranged on the node side of vibration. Accordingly, the vibration transmissibility between the shaft 16 and the tubular portion 18 is reduced, and it is possible to suitably reduce the vibration transmitted to the handle 26.

It should be noted that the present invention is not limited to the embodiment described above, and it goes without saying that various configurations could be adopted therein on the basis of the descriptive content of the present specification.

1. A portable work machine comprising:
a drive unit;
a working unit driven by power of the drive unit;
a shaft configured to transmit the power of the drive unit to the working unit;
a tubular portion which is disposed between the drive unit and the working unit, and in which the shaft is inserted;
a plurality of bearing members configured to support the shaft inside the tubular portion;
a handle support portion connected to an outer peripheral surface of the tubular portion; and
a handle supported by the handle support portion and gripped by an operator, wherein
the shaft includes a first region facing the handle support portion and corresponding to an antinode of vibration generated in the shaft, and
the plurality of bearing members are arranged inside the tubular portion, at locations other than the first region along a longitudinal direction of the shaft.

2. A portable work machine comprising:
a drive unit;
a working unit driven by power of the drive unit;
a shaft configured to transmit the power of the drive unit to the working unit;
a tubular portion which is disposed between the drive unit and the working unit, and in which the shaft is inserted;
a plurality of bearing members configured to support the shaft inside the tubular portion;
a handle support portion connected to an outer peripheral surface of the tubular portion; and
a handle supported by the handle support portion and gripped by an operator, wherein
the shaft includes a first region facing the handle support portion and corresponding to an antinode of vibration generated in the shaft,
two first bearing members among the plurality of bearing members are arranged so as to sandwich the first region, and
an interval between the two first bearing members is wider than an interval between each of the two first bearing members and another bearing member that are adjacent to each other on an outer side of the first region along a longitudinal direction of the shaft.

3. The portable work machine according to claim 1, wherein
two first bearing members among the plurality of bearing members are arranged so as to sandwich the first region, and
an interval between the two first bearing members is set to a length corresponding to a frequency of the vibration.

4. The portable work machine according to claim 3, wherein
the vibration at a plurality of frequencies is generated in the shaft and the tubular portion,
a second region is provided in the shaft along the longitudinal direction separately from the first region in order to cope with the vibration at the plurality of frequencies,
the second region corresponds to an antinode of vibration different from the vibration corresponding to the first region,
two second bearing members are arranged so as to sandwich both ends of the second region, and
an interval between the two second bearing members is set to a length corresponding to a frequency of the vibration corresponding to the second region.

5. The portable work machine according to claim 4, wherein
a frequency of the vibration corresponding to the first region corresponds to a frequency of vibration of the working unit, and
the frequency of the vibration corresponding to the second region corresponds to a frequency of vibration of the drive unit.
